(19) United States
(12) Patent Application Publication
(10) Pub. No.: US 2007/0057809 A1
(43) Pub. Date: Mar. 15, 2007

(54) Wireless controlled emergency power supply device for a transit vehicle

(76) Inventor: Chien-Hsin Su, Jhubei City (TW)

Correspondence Address: John S. Egbert;Egbert Law Office, 412 Main Street, 7th Floor, Houston, TX, 77002, US

(21) Appl. No.: 11/226,603

(22) Filed: Sep. 15, 2005

(51) Int. Cl. G08C 19/00

(52) U.S. Cl. 340/825.69

(57) ABSTRACT

The remote controlled emergency power supply device for a transit vehicle, and more particularly to a remote controlled system that can be operated from a long distance, includes a remote control unit, receiving control unit, supply unit and power consumption unit. The remote control unit's sending end and the rest of the unit can be placed outside the vehicle, and the remote control unit may be initiated by the connection of the mobile phone, satellite or other wireless communication system to start the receiving control unit. The receiving control unit may control the supply unit to power the power consumption unit to achieve the purpose of letting user control the unit from long distance away, and the power consumption does not affect the original power of the vehicle.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a wireless controlled emergency power supply device, and more particularly to a remote controlled system that can be operated from a long distance, and its supply unit may use the emergency power supple and not affect its original power.

### BACKGROUND OF THE INVENTION

Currently, the air conditioner and heater of the conventional transit vehicle can only be used after the vehicle is warmed up, the reason for that is it is very power-consuming, therefore, the power in the bottle is used up very quickly when it is used constantly, and makes the vehicle hard to start. The current vehicle does not have any control circuit or extra power supplier for the operators to use before they go into the vehicle or after the vehicle is shut off. So if the air conditioner and the heater is used after the vehicle is shut off, it can cause the power to reduce speedily and the vehicle may not start. There is no in-car temperature adjustment system that can be used after the vehicle is shut off or before the vehicle is started in the market today. On one hand, also because after the vehicle is shut off and operator leaves, it does not need air conditioning system in the vehicle under regular circumstances; however, in the hot summer day or cold winter day, if the temperature in the vehicle can be maintained in a certain comfortable degree before the vehicle is started, the hot or cold temperature will not be so unbearable.

On the other hand, even regular remote control can achieve the remote control purposes, however, its remote controlled distance is restricted to be only few feet over ten feet or shorter, therefore, after leaving that distance, the remote functions cease to work, and under regular circumstances, after the vehicle is parked, it leaves that distance anyway, therefore, the remote control generally does not have any function from a long distance.

Moreover, the vehicle battery is widely limited to certain amount of electricity, therefore, before using air conditioner and heater, the vehicle must be started first to supply the power continually.

### BRIEF SUMMARY OF THE INVENTION

The remote controlled emergency power supply device for transit vehicle, and more particularly to a remote controlled system that can be operated from a long distance, includes a remote control unit, receiving control unit, supply unit and power consumption unit. The remote control unit's sending end and the rest of the unit can be placed outside the vehicle, and the remote control unit may be initiated by the connection of the mobile phone, satellite or other wireless communication system to start the receiving control unit. The receiving control unit may control the supply unit to power the power consumption unit to achieve the purpose of letting user control the unit from long distance away, and the power consumption does not affect the original power of the vehicle.

### BRIEF DESCRIPTION OF THE SEVERAL VIEWS OF THE DRAWINGS

FIG. 1 shows a schematic view of a system organizational chart of the present invention.

FIG. 2 shows another schematic view of the system organizational chart of the application of the present invention.

FIG. 3 shows another schematic view of a system organizational chart of the present invention.

FIG. 4 shows a schematic view of the embodiment comprising the emergency power supplier and the original power supplier.

FIG. 5 shows still another schematic view of the function's of the emergency power supplier integrated to the embodiment of the power supplier and emergency power management.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

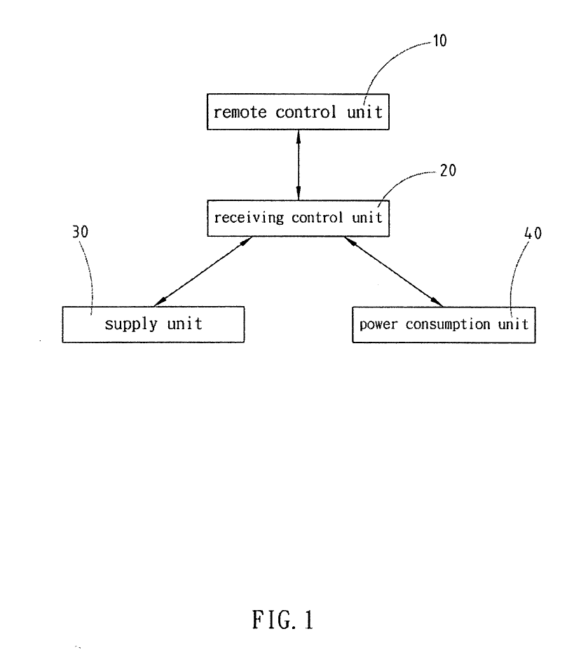

As shown in FIG. 1, there is an organizational chart for the wireless controlled emergency power supply device for transit vehicle. Translation of the term “unit” may also be substituted for “means” in English.

The invention includes a remote control unit 10, which can be operated by the user from long distance away without restriction on the distance, and the remote control equipment can be mobile phone, GPS, satellite communication, other wireless communication system (such as WLAN, WMAN, WWAN), independent wireless switch or remote control or advance vehicle computer system that has reply function;

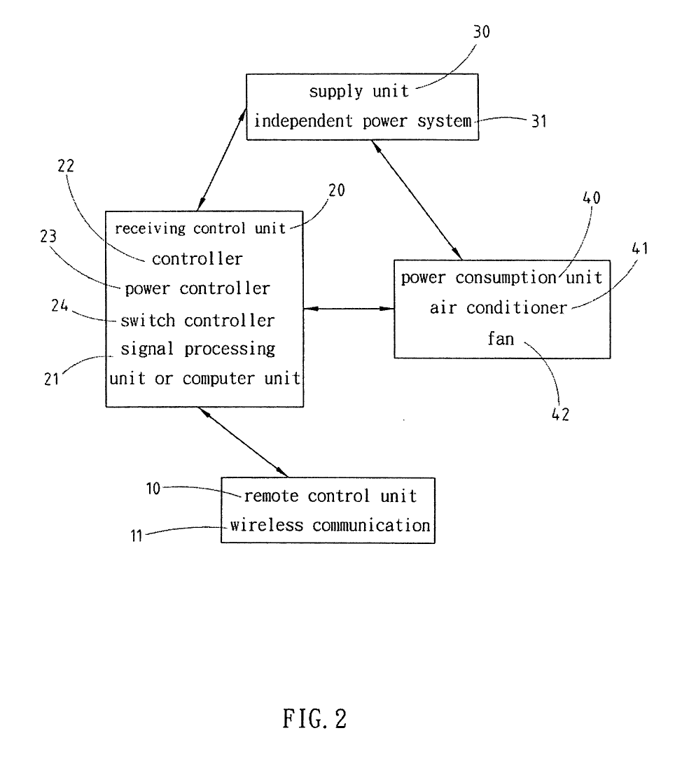

The invention includes a receiving control unit 20, and the receiving control unit 20 may be a switch controller or energy management controller; the receiving control unit 20 receives signal, or process it through the signal processing unit or computer unit 21 (see FIG. 2), and it may control the power consumption unit 40.

There is a supply unit 30, which may be a solar powered battery, power supplier or battery.

There is also a power consumption unit 40, which may be a fan or air conditioner and heater or other load.

Based on the abovementioned structure, the remote control unit 10 responds to the receiving control unit 20 of the remote control equipment that user can operate from a long distance in the vehicle, and after the receiving control unit 20 receives the signal, it is processed through the signal processing unit and computer unit, so that receiving control unit 20 may provide power to the supply unit 30, and the power is provided for the power consumption unit 40 in the vehicle to achieve the purpose of controlling the power consumption unit in the vehicle from long distance away and start the power consumption unit.

As shown in FIG. 2, its application is a temperature adjustment system for vehicle, and this system is a solution designed for the conditions when the temperature is too high or too low in the vehicle after it is shut off or before it starts under the circumstances where it is very hot or very cold; this system comprises a supply unit 30, which is an independent power system 31, a controller 22 and an air conditioner and heater 41, and the air conditioner 41 is one of the power consumption unit 40. The independent power system 31 is the power sources for the fan 42 or the air conditioner and heater 41, with special power controller 23 or switch controller 24, it may adjust the air in and outside the vehicle by intermittent fan 42 according to the temperature and time reference, or by responding to the wireless communication 11 or remote control unit 10 the users use from a long distance to solve the problem with the temperature being too high or too low before the operator go in and start the air conditioning system in the vehicle.

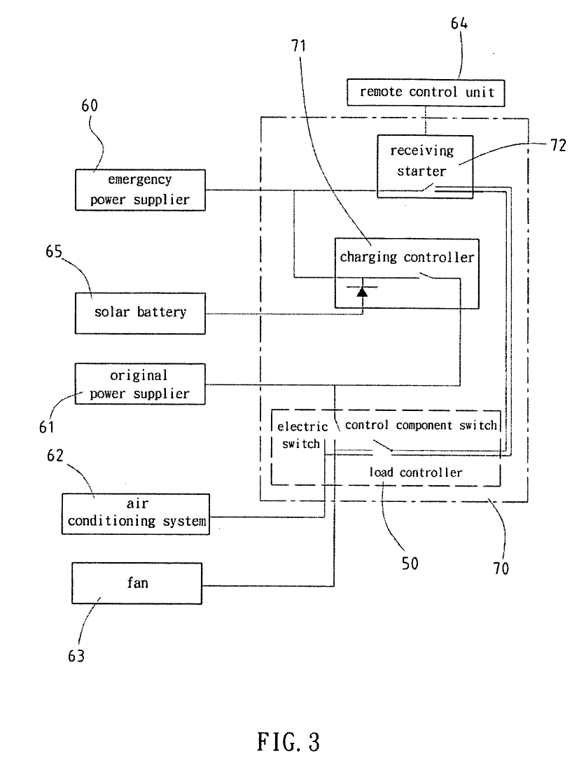

As shown in FIG. 3, which is another embodiment of the present invention comprising an emergency power supplier 60 (also called back up battery), an original power supplier 61, an air conditioning system 62, a fan 63, a remote control unit 64, a receiving control unit 70 and a load controller 50.

The method and device operate as follows:

A. When the vehicle is starting, the switch 71 of the charging controller of the receiving control unit 70 may be turned on, and the generator of the vehicle can charge the emergency power supplier 60 and the original power supplier 61.

B. After the vehicle is shut off, the switch 71 of the charging controller of the receiving control unit 70 is turned off to avoid the air conditioning system 62 from starting and using the original power supplier 61 after the vehicle is shut off, and cause the engine hard to start (the emergency power supplier) may also be the solar powered battery or emergency power supplier may add solar powered battery 62, which can be charged when the sun is up.

C. When the temperature is too high, the receiving control unit 70 controls the amount of electricity the emergency power supplier 60 provides to the fan 63, when the time and temperature achieves designated temperature, or the fan stops when the amount of electricity is low to a certain degree, and by so doing to adjust the air flow inside and outside the vehicle, so that the amount of electricity consumption would be low and it may be charged with solar powered battery.

D. Before the vehicle shut off or the operator enters into the vehicle, the user may first start air conditioning system 62 to pre-cool or pre-heat, in terms of controlling, it uses remote control unit 64 that has not distance restriction, and after it is initiated by the receiving starter 72 of the receiving control unit 70, the emergency power supplier 60 provides power for air conditioning system 62, so that it can maintain a comfortable temperature in the vehicle under the circumstances where it will not affect the power supply of the original power supplier 61, and in terms of operation, it may be operated by the designated time on the receiving control unit 70 directly to make it start or stop automatically.

FIG. 3 is an embodiment of the load that uses air conditioning, if it is other load, it can be described as follows.

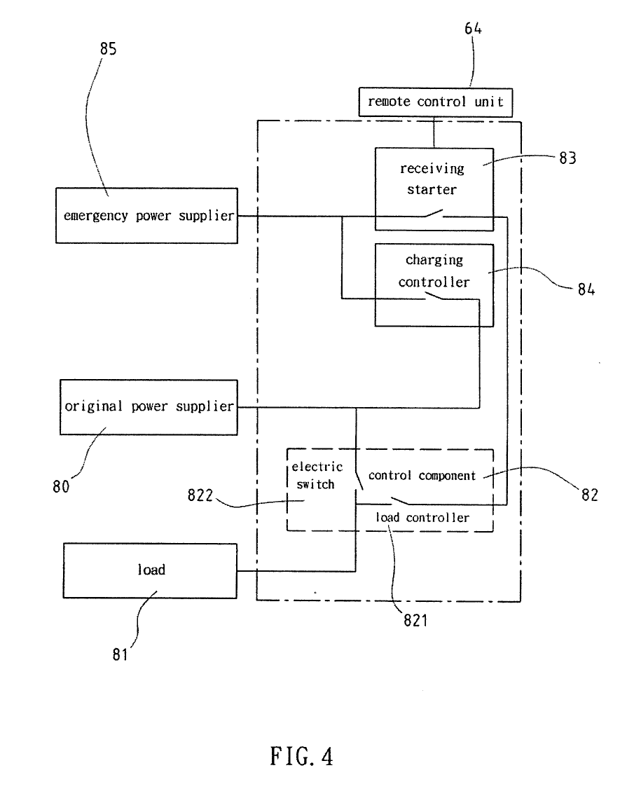

As shown in FIG. 4, the components and the functions thereof are:
(A) Original power supplier 80: It offers the power needed for the vehicle, which includes generator and batteries.
(B) Load: Desired electrical unit or device that can be used after the vehicle is shut off or when the operator is not driving, such as fan or air conditioner and heater.
(C) Emergency power supplier 85: It provides the power needed after the vehicle is shut off or when the operator is not driving to keep the load system from using the original power supplier and cause the engine to fail to start, therefore, the emergency power supplier is used to solve this problem.
(D) Remote control unit 64: Which includes remote control unit's signal sending and receiving module, after the signal-sending module sent the signal to initiate the load, and it is transmitted through the ground station or satellite to remote control unit receiving end, and the receiving end transmit the signal to the receiving starter 83 of the receiver unit.
(E) Receiving starter 83: It receives the signal from the receiving end of remote control unit, and controls the emergency power supplier to the switch of the load, and the simplest receiving starter is a connecting control line or switch.
(F) Load controller 82: It controls the energy switch needed for the load, which is provided from the original power supplier or the emergency power supplier, and it mainly includes (1) from the load to the original power supplier to electric switch 822, and (2) from the load to the emergency power supplier to the control component 821.
(G) Charging controller 84: After the engine is started, it controls the charging activity for the emergency power supplier, and after the engine is shut off, the electrical flow for charging controller is stopped to keep the load system from using the electricity from the original power supplier.

The following is the embodiment for FIG. 4, and the condition of the vehicle is described as follows:
(1) While the vehicle is being operated: The power needed for the load is supplied by the original power supplier, and at this time, the electric switch 822 starts the short and the usage of the load is controlled by the load controller, and control component 822 breaks, meanwhile, the charging controller 84 controls the original power supplier 80 for the charging activity of the emergency power supplier.
(2) After the vehicle is shut off: To keep the load system from using the power from the original power supplier 80, the electric switch 822 is closed to form a break, and make electrical short in control component 821, and the charging controller 84 forms a break, meanwhile, under a preset value and proactive condition, the load controller 82 and the receiving starter 83 will prepare to control the movement for the load from the signal sending end of the remote control.
(3) Take the air conditioning in the vehicle as the load for example: Before the operator enters into the vehicle, the uses initiate the starting signal by remote control unit 64, and through the receiving module of the remote control unit 64 to initiate the air conditioning load 83 with receiving starter 83, at this time, the emergency power supplier 85 offers the power supply to the air conditioning load instead of using the power from the original power supplier.

The embodiment of FIG. 4 is described with the switch functions:
(1) Electric switch 822 of the load controller and the switch 821 for the control component:
   (A) Electric switch--on, control component--off: The load is powered by original power supplier.
   (B) Electric switch--off, control component--on: The load is powered by the emergency power supplier.
   (C) Electric switch--on, control component--off: Not permitted.
   (D) Electric switch--off, control component--on: At this time, the load would not connect to any power supplier, which is not applicable.
(2) Charging controller:
   (A) Charging controller--on: Charging controller controls the charging activity of the original power supplier for the emergency power supplier.
   (B) Charging controller--off: The load is powered by the emergency power supplier, therefore, the charging controller must be off.
(3) Receiving starter: After the vehicle is shut off, the electric switch--off, control component--on, charging controller--off, at this time, the receiving starter is in proactive state waiting for the commend from the sending end of the remote control unit 10, which is the commend of the operator.

The above switches may be achieved by the manual switch, relay switch or semi-conductor switch and or other combined electrical circuit.

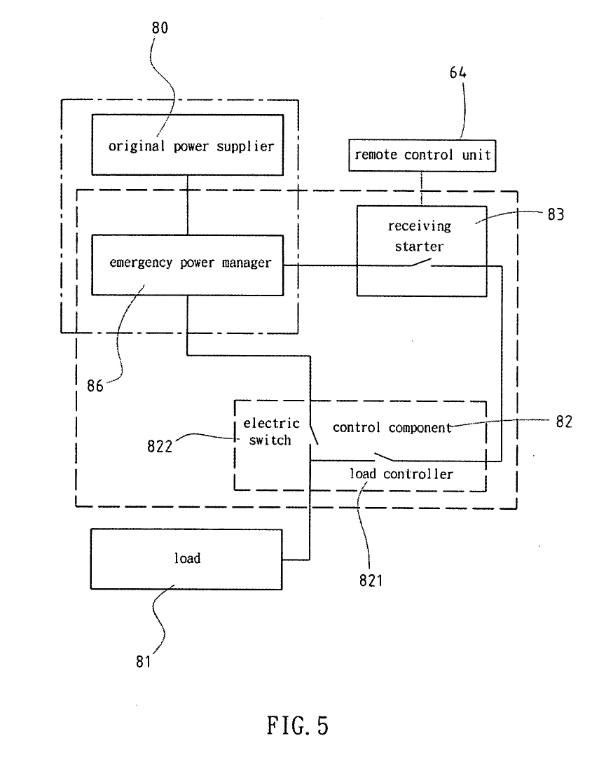

As shown in FIG. 5, there is a description of the main components and emergency power manager 86.

The emergency power manager 86 is to replace the functions of emergency power supplier 85 (as shown in FIG. 4), and to achieve the purpose by the detector inside the battery, and the objective is to provide the power needed after the vehicle shuts off or while the operator is not driving; if the load system 81 uses the electricity of the original power supplier 80, it then uses the battery detector of the emergency power manager 86, and if it is low to the limit for starting the engine, it shuts off the power supplier to avoid the engine from failing to start after the engine is shut off if the system uses too much of original power supplier, and the function of the emergency power supplier is therefore achieved.

Although the invention has been explained in relation to its preferred embodiment, it is to be understood that many other possible modifications and variations can be made without departing from the spirit and scope of the invention as hereinafter claimed.

I claim:

1. A wireless controlled emergency power supply device for a transit vehicle, comprising:
a remote control means being operable from a long distance with remote control;
a receiving control means being a control for receiving a signal, or providing power to a power consumption unit by a supply end through a signal processing unit or power management processing analyzing all references;
a supply means having a power supply; and
a power consumption means having all types of consumption equipment inside and outside the vehicle;
wherein the remote control unit, and the receiving control unit start the power consumption means, and the supply means provides power.

2. A wireless controlled emergency power supply device for a transit vehicle, comprising:
a remote control means being operable from a long distance with remote control; and
a receiving control means being able to receive and initiate, charge and control, a relevant controlling movement of load control being remote controlled or preset to maintain minimum power, and being able to receive a receiver means and connect a power consumption means and a supply means;
wherein long distant remote control or preset control functions of the receiving control means are achieved, the receiving control means control being the power consumption means, the power needed for the power consumption means being powered by the supply means.

3. A wireless controlled emergency power supply device for a transit vehicle, comprising:
a receiving control means being able to receive and initiate, charge and control, a relevant controlling movement of load control being remote controlled or preset to maintain minimum power, and being able to receive a receiver means and connect a power consumption means and a supply means, being operable by a remote control means to achieve the long distant remote control or preset control functions of the receiver means, making a receiver means control the power consumption means, the power needed for the power consumption means being powered by the supply means.

4. A wireless controlled emergency power supply device for a transit vehicle, comprising:
a remote control means being operable from a long distance with remote control;
a supply means having a power supply; and
a receiving control means being able to receive and initiate, charge and control, a relevant controlling movement of the load control being remote controlled or preset to maintain minimum power, and being able to receive a receiver means and connect a power consumption means and a supply means;
wherein long distant remote control or preset control functions of the receiver unit are achieved, making the receiver means control the power consumption means, and the power needed for the power consumption means being powered by the supply means.

5. A wireless controlled emergency power supply device for a transit vehicle, comprising:
a supply means having a power supply; and
a receiving control means being able to receive and initiate, charge and control, a relevant controlling movement of the load control being remote controlled or preset to maintain minimum power, and being able to receive a receiver means and connect a power consumption means and supply means; being operable by a remote control unit to achieve the long distant remote control or preset control functions of the receiver means, making the receiver means control the power consumption means, and the power needed for the power consumption means being powered by the supply means.

6. The structure defined in claim 1, wherein said power consumption unit is comprised of a fan, air conditioner and heater, air conditioning system or other load, and the supply means is comprised of a power supplier or battery or solar powered battery or combination thereof, and the receiving control means is comprised of a switch controller or power management controller, charging sources being a power supplier, generator, battery or solar powered battery or combination thereof.

7. The structure defined in claim 1, wherein said power consumption means is initiated by the receiving control means or remote controllable or preset value, or being detected by power energy management or control, and wherein a receiver starter of the receiving control unit receives the signal from remote control unit to control the emergency power supplier to the load switch.

8. A wireless controlled emergency power supply device for a transit vehicle, comprising:
a remote control means being operable from a long distance with remote control;
a receiving control means having a control switch for receiving signal, or switch for emergency power supply and switch for original power supply;
an emergency power supply means comprised of a power supplier or battery;
an original power supply or an air conditioning system, and
a load controller placed between the original power supply and air conditioning system;
wherein the generator in the vehicle charges the emergency power supply and original power supply or the solar powered battery charges the emergency battery, so that after the vehicle is shut off or before the operator enters into to the vehicle, the user may pre-start the vehicle by the receiver unit or start the emergency power supply by controlling the receiving control unit by remote control unit, and to adjust the temperature inside the vehicle with air conditioning system; moreover, its receiving control unit can use emergency power supply to control the fan with intermittent temperature adjustment according the temperature inside the vehicle and the time references and amount of electricity.

9. The structure defined in claim 8, wherein said emergency power supply is comprised of replaceable solar power, or added with solar power.

10. The structure defined in claim 8, wherein, when started, the electric switch of the load controller of a original power control switch thereof and the switch for charging controller are both on to charge the original power supply and emergency power supply, and after the vehicle is shut off, the electric switch of the load controller and the controller switch for the charging controller are both off, only the control component of the load controller may be on.

11. A wireless controlled emergency power supply device for a transit vehicle, comprising:
a load means connected to n original power supplier with an electric switch for a load controller;
an original power supplier or emergency power supplier means with a charging controller connection; and
an emergency power supplier means connected to the load that has receiver starter that receives signal and the switch for control component of the load controller;
wherein, when the vehicle is started, the original power supply is used and the emergency power supplier is charged or the emergency power supplier is charged with solar powered battery, and after the vehicle is shut off or before the operator enters into the vehicle, user may control the starting signal by remote control unit, and controls emergency power supply load by the control component of the load controller.

12. The structure defined in claim 11, wherein the load means is comprised of an electrical equipment or device, fan or air conditioner and heater, a receiving starter means receiving a signal of remote control unit, and by so doing, controlling the switch from the emergency power supplier to the load.

13. The structure defined in claim 11, wherein said emergency power supplier means is comprised of a power supplier or battery or solar powered battery or the combination thereof, and the charging resources are comprised of original power supplier, generator or solar power or the combination thereof, or the emergency power supplier or charging controller may be cancelled, and the original power supplier is connected to the emergency power manager to ensure that power consumption stays at the minimum, so that the vehicle may be started.

14. The structure defined in claim 11, wherein the switch means is comprised of a manual switch, relay switch or semi-conductor switch and or other combined electrical circuit.

15. The structure defined in claim 11, wherein said receiving starter means is comprised of a connecting control line, switch or circuit.

16. The structure defined in claim 1, wherein said remote control may be means is comprised a mobile phone system, GPS, satellite communication system, wireless communication system, independent wireless switch controller or advanced in-car computer that has wireless communication function, which includes sender or receiver.
